(19) United States
(12) Patent Application Publication
(10) Pub. No.: US 2019/0362151 A1
(43) Pub. Date: Nov. 28, 2019

(54) STREAMING VIRTUAL REALITY VIDEO

(71) Applicant: Koninklijke KPN N.V., Rotterdam (NL)

(72) Inventors: Hans Maarten Stokking, Wateringen (NL); Omar Aziz Niamut, Vlaardingen (NL); Simon Norbert Bernard Gunkel, Duivendrecht (NL)

(21) Appl. No.: 16/332,773

(22) PCT Filed: Sep. 12, 2017
(86) PCT No.: PCT/EP2017/072800

§ 371 Date: Mar. 12, 2019

(30) Foreign Application Priority Data
Sep. 14, 2016 (EP) 16188706.2

(51) Int. Cl. G06K 9/00; G06T 19/00; G06F 3/01; G06T 7/73; H04N 13/117; H04N 13/371; H04L 29/06

(52) U.S. Cl. CPC G06K 9/00671; G06T 19/006; G06F 3/012; H04L 65/4069; H04N 13/117; H04N 13/371; G06T 7/74

(57) ABSTRACT

Methods and devices are provided for use in streaming a Virtual Reality [VR] video to a VR rendering device. The VR video may be represented by a plurality of streams each providing different image data of a scene. The VR rendering device may render a selected view of the scene on the basis of a first subset of streams. A second subset of streams may then be identified which provides image data of the scene which is spatially adjacent to the image data of the first subset of streams, e.g., on the basis of spatial relation data. Having identified the second subset of streams, a caching of the second subset may be effected in a network cache which is comprised downstream of the one or more stream sources in the network and upstream of the VR rendering device. The second subset of streams may effectively represent a ‘guard band’ for the image data of the first subset of streams. By caching this ‘guard band’ in the network cache, the delay between the requesting of one or more streams from the second subset and their receipt by the VR rendering device may be reduced.

### FIELD OF THE INVENTION

The invention relates to a method of streaming Virtual Reality [VR] video to a VR rendering device. The invention further relates to a computer program comprising instructions for causing a processor system to perform the method, to the VR rendering device, and to a forwarding node for use in the streaming of the VR video.

### BACKGROUND ART

Virtual Reality (VR) involves the use of computer technology to simulate a user's physical presence in a virtual environment. Typically, VR rendering devices make use of Head Mounted Displays (HMD) to render the virtual environment to the user, although other types of VR displays and rendering techniques may be used as well, including but not limited to holography and Cave automatic virtual environments.

It is known to render VR video using such VR rendering devices, e.g., a video that is suitable for being played-out by a VR rendering device. The VR video may provide a panoramic view of a scene, with the term ‘panoramic view’ referring to, e.g., an at least 180 degree view. The VR video may even provide larger view, e.g., 360 degrees, thereby providing a more immersive experience to the user.

A VR video may be streamed to a VR rendering device as a single video stream. However, if the entire panoramic view is to be streamed in high quality and possibly in 3D, this may require a large amount of bandwidth, even when using modern video encoding techniques. For example, the bandwidth requirements may easily reach tens or hundreds of Mbps. As VR rendering devices frequently stream the video stream via a bandwidth constrained access network, e.g., a Digital Subscriber Line (DSL) or Wireless LAN (WLAN) connection or Mobile connection (e.g. UMTS or LTE), the streaming of a single video stream may place a large burden on the access network or such streaming may even not be feasible at all. For example, the play-out may be frequently interrupted due to re-buffering, instantly ending any immersion for the user. Moreover, the receiving, decoding and processing of such a large video stream may result in high computational load and/or high power consumption, which are both disadvantageous for many devices, esp. mobile devices.

It has been recognized that a large portion of the VR video may not be visible to the user at any given moment in time. A reason for this is that the Field Of View (FOV) of the display of the VR rendering device is typically significantly smaller than that of the VR video. For example, a HMD may provide a 100 degree FOV which is significantly smaller than, e.g., the 360 degrees provided by a VR video.

As such, it has been proposed to stream only parts of the VR video that are currently visible to a user of the VR rendering device. For example, the VR video may be spatially segmented into a plurality of (usually) non-overlapping video streams which each provide a different view of the scene. When the user changes viewing angle, e.g., by rotating his/her head, the VR rendering device may determine that another video stream is needed (henceforth also simply referred to as ‘new’ video stream) and switch to the new video stream by requesting the new video stream from a stream source.

Disadvantageously, the delay between the user physically changing viewing angle, and the new view actually being rendered by the VR rendering device, may be too large. This delay is henceforth also referred to as ‘switching latency’, and is sizable due to an aggregate of delays, of which the delay between requesting the new video stream and the new video stream actually arriving at the VR rendering device is typically the largest. Other, typically less sizable delays include delays due to the decoding of the video streams, delays in the measurement of head rotation, etc.

Various attempts have been made to address the latency problem. For example, it is known to segment the plurality of video streams into partially overlapping views, thereby providing so-termed ‘guard bands’ which contain video content just outside the current view. The size of the guard bands is typically dependent on the speed of head rotation and the latency of switching video streams. Disadvantageously, given a particular bandwidth availability, the use of guard bands reduces the video quality given a certain amount of available bandwidth, as less bandwidth is available for the video content actually visible to the user. It is also known to predict which video stream will be needed, e.g., by predicting the user's head rotation, and request and stream the new video stream in advance. However, as in the case of guard bands, bandwidth is then also allocated for streaming non-visible video content, thereby reducing the bandwidth available for streaming currently visible video content.

It is also known to prioritize I-frames in the transmission of new video streams. Here, the term I-frame refers to an independently decodable frame in a Group of Pictures (GOP). Although this may indeed reduce the switching latency, the amount of reduction may be insufficient. In particular, the prioritization of I-frames does not address the typically sizable delay between requesting the new video stream and the packets of the new video stream actually arriving at the VR rendering device.

US20150346832A1 describes a playback device which generates a 3D representation of the environment which is displayed to a user of the customer premise device, e.g., via a head mounted display. The playback device is said to determine which portion of the environment corresponds to the users main field of view. The device then selects that portion to be received at a high rate, e.g., full resolution with the stream being designated, from a priority perspective, as a primary stream. Content from one or more other streams providing content corresponding to other portions of the environment may be received as well, but normally at a lower data rate.

A disadvantage of the playback device of US20150346832A1 is that it may insufficiently reduce switching latency. Another disadvantage is that the playback device may reduce the bandwidth available for streaming visible video content.

### SUMMARY OF THE INVENTION

It would be advantageous to obtain a streaming of VR video which addresses at least one of the abovementioned problems of US20150346832A1.

The following aspects of the inventions involve a VR rendering device rendering, or seeking to render, a selected view of the scene on the basis of a first subset of a plurality of streams. In response, a second subset of streams which provides spatially adjacent image data may be cached in a network cache. It is thus not needed to indiscriminately cache all of the plurality of streams in the network cache.

In accordance with a first aspect of the invention, a method may be provided for use in streaming a VR video to a VR rendering device, wherein the VR video may be represented by a plurality of streams each providing different image data of a scene, wherein the VR rendering device may be configured to render a selected view of the scene on the basis of one or more of the plurality of streams.

The method may comprise:
obtaining spatial relation data which is indicative of a spatial relation between the different image data of the scene as provided by the plurality of streams;
identifying the one or more streams which are needed to render the selected view, thereby identifying a first subset of streams;
identifying, by using the spatial relation data, a second subset of streams which provides image data of the scene which is spatially adjacent to the image data of the first subset of streams;
obtaining stream metadata which identifies one or more stream sources providing access to the second subset of streams in a network; and
effecting a caching of the second subset of streams in a network cache which is comprised downstream of the one or more stream sources in the network and upstream of the VR rendering device.

In accordance with a further aspect of the invention, transitory or non-transitory computer-readable medium may be provided comprising a computer program. The computer program may comprise instructions for causing a processor system to perform the method.

In accordance with a further aspect of the invention, a network cache may be provided for use in streaming a VR video to a VR rendering device. The network cache may comprise:
an input/output interface for communicating with a network;
a data storage for caching data;
a cache controller configured to:
   obtain spatial relation data which is indicative of a spatial relation between the different image data of the scene as provided by the plurality of streams;
   identify the one or more streams which are needed to render the selected view, thereby identifying a first subset of streams;
   identify, by using the spatial relation data, a second subset of streams which provides image data of the scene which is spatially adjacent to the image data of the first subset of streams;
   obtain stream metadata which identifies one or more stream sources providing access to the second subset of streams in the network;
   request, using the input/output interface, a streaming of the second subset of streams from the one or more stream sources; and
   cache the second subset of streams in the data storage.

In accordance with a further aspect of the invention, a VR rendering device may be provided. The VR rendering device may comprise:
a network interface for communicating with a network;
a display processor configured to render a selected view of the scene on the basis of one or more of the plurality of streams; and
a controller configured to:
   obtain spatial relation data which is indicative of a spatial relation between the different image data of the scene as provided by the plurality of streams;
   identify the one or more streams which are needed to render the selected view, thereby identifying a first subset of streams;
   identify, by using the spatial relation data, a second subset of streams which provides image data of the scene which is spatially adjacent to the image data of the first subset of streams; and
   effect a caching of the second subset of streams in a network cache which is comprised downstream of the one or more stream sources in the network and upstream of the VR rendering device by sending, using the network interface, a message to the network cache or to one or more stream sources which provide access to the second subset of streams in the network, wherein the message comprises instructions to cache the second subset of streams in the network cache.

The above measures may involve a VR rendering device rendering a VR video. The VR video may be constituted by a plurality of streams which each, for a given video frame, may comprise different image data of a scene. The plurality of streams may be, but do not need to be, independently decodable streams or sub-streams. The plurality of streams may be available from one or more stream sources in a network, such as one or more media servers accessible via the internet. The VR rendering device may render different views of the scene over time, e.g., in accordance with a current viewing angle of the user, as the user may rotate and/or move his or her head during the viewing of the VR video. Here, the term ‘view’ may refer to the rendering of a spatial part of the VR video which is to be displayed to the user, with this view being also known as ‘viewport’. During the use of the VR rendering device, different streams may thus be needed to render different views over time. During this use, the VR rendering device may identify which one(s) of the plurality of streams are needed to render a selected view of the scene, thereby identifying a subset of streams, which may then be requested from the one or more stream sources. Here, the term ‘subset’ is to be understood as referring to ‘one or more’. Moreover, the term ‘selected view’ may refer to any view which is to be rendered, e.g., in response to a change in viewing angle of the user. It will be appreciated that the functionality described in this paragraph may be known per se from the fields of VR and VR rendering.

The above measures may further effect a caching of a second subset of streams in a network cache. The second subset of streams may comprise image data of the scene which is spatially adjacent to the image data of the first subset of stream, e.g., by the image data of both sets of streams representing respective regions of pixels which share a boundary or partially overlap each other. To effect this caching, use may be made of spatial relation data which may be indicative of a spatial relation between the different image data of the scene as provided by the plurality of streams, as well as stream metadata which may identify one or more stream sources providing access to the second subset of streams in a network. A non-limiting example is that the spatial relation data and the stream metadata may be obtained from a manifest file associated with the VR video in case MPEG DASH or some other form of HTTP adaptive streaming is used. The network cache may be comprised downstream of the one or more stream sources in the network and upstream of the VR rendering device, and may thus be located nearer to the VR rendering device than the stream source(s), e.g., as measured in terms of hops, ping time, number of nodes representing the path between source and destination, etc. It will be appreciated that a network cache may even be positioned very close to the VR rendering device, e.g., it may be (part of) a home gateway, a settop box or a car gateway. For example, a settop box may be used as a cache for a HMD which is wirelessly connected to the home network, wherein the settop box may have a high-bandwidth (usually fixed) network connection and the network connection between the settop box and the HMD is of limited bandwidth.

As the second subset of streams comprises spatially adjacent image data, there is a relatively high likelihood that one or more streams of the second subset may be requested by the VR rendering device. Namely, if the first subset of streams is needed by the VR rendering device to render a current view of the scene, the second subset of streams may be needed by the VR rendering device when rendering a following view of the scene, e.g., in response to a change in viewing angle of the user. As each change in viewing angle is typically small and incremental, the following view may most likely overlap with the current view, while at the same time also showing additional image data was previously not shown in the current view, e.g., spatially adjacent image data. Effectively, the second subset of streams may thus represent a sizable ‘guard band’ for the image data of the first subset of streams.

By caching this ‘guard band’ in the network cache, the delay between the requesting of one or more streams from the second subset and their receipt by the VR rendering device may be reduced, e.g., in comparison to a direct requesting and streaming of said stream(s) from the stream source(s). Shorter network paths may yield shorter end-to-end delays, less chance of delays due to congestion of the network by other streams as well as reduced jitter, which may have as advantageous effect that there may be less need for buffering at the receiver. A further effect may be that the bandwidth allocation between the stream source(s) and the network cache may be reduced, as only a subset of streams may need to be cached at any given moment in time, rather than having to cache all of the streams of the VR video. The caching may thus be a ‘selective’ caching which does not cache all of the plurality of streams. As such, the streaming across this part of the network path may be limited to only those streams which are expected to be requested by the VR rendering device in the intermediate future. Similarly, the network cache may need to allocate less data storage for caching, as only a subset of streams may have to be cached at any given moment in time. Similarly, less read/write access bandwidth to the data storage of the network cache may be needed.

It is noted the above measures may be performed incidentally, but also on a periodic or continuous basis. An example of the incidental use of the above measures is where a VR user is mostly watching in one direction, e.g., facing one other user. The image data of the other user may then delivered to the VR rendering device in the form of the first set of streams. Occasionally, the VR user may briefly look to the right or left. The network cache may then deliver image data which is spatially adjacent to the image data of the first subset of streams in the form of a second subset of streams.

In case the above measures are performed periodically or continuously, the first subset of streams may already be delivered from the network cache if it has been previously cached in accordance with the above measures, e.g., as a previous ‘second’ subset of streams in a previous iteration of the caching mechanism. In the current iteration, a new ‘second’ subset of streams may be identified and subsequently cached which is likely to be requested in the nearby future by the VR rendering device.

It is further noted that the second subset of streams may be further selectively cached in time, in that only the part of a stream's content timeline may be cached which is expected to be requested by the VR rendering device in the nearby future. As such, rather than caching all of the content timeline of the second subset of streams, or rather than caching a same part of the content timeline as provided by the first subset of streams being delivered, a following or future part of the content timeline of the second subset of streams may be cached. A specific example yet non-limiting may be the following. In HTTP Adaptive Streaming (HAS), such as MPEG DASH, a representation of a stream may consist of multiple segments in time. To continue receiving a certain stream, separate requests may be sent for each part in time. In this case, if the first subset of streams represents a ‘current’ part of the content timeline, an intermediately following part of the second subset of streams may be selectively cached. Alternatively or additionally, other parts in time may be cached, e.g., being positioned further into the future, or partially overlapping with the current part, etc. The selection of which part in time to cache may be a function of various factors, as further elucidated in the detailed description with reference to various embodiments.

In an embodiment, the method may further comprise:
obtaining a prediction of which adjacent image data of the scene may be rendered by the VR rendering device; and
identifying the second subset of streams based on the prediction.

As such, rather than indiscriminately caching the streams representing a predetermined spatial neighborhood of the current view, a prediction is obtained of which adjacent image data of the scene may be requested by the VR rendering device for rendering, with a subset of streams then being cached based on this prediction. This may have as advantage that the caching is more effective, e.g., as measured as a cache hit ratio of the requests able to be retrieved from a cache to the total requests made, or the cache hit ratio relative to the number of streams being cached.

In an embodiment, the VR rendering device may be configured to determine the selected view of the scene in accordance with a head movement and/or head rotation of a user, and the obtaining the prediction may comprise obtaining tracking data indicative of the head movement and/or the head rotation of the user. The head movement and/or the head rotation of the user may be measured over time, e.g., tracked, to determine which view of the scene is to be rendered at any given moment in time. The tracking data may also be analyzed to predict future head movement and/or head rotation of the user, thereby obtaining a prediction of which adjacent image data of the scene may be requested by the VR rendering device for rendering. For example, if the tracking data comprises a series of coordinates as a function of time, the series of coordinates may be extrapolated in the near future to obtain said prediction.

In an embodiment, the method may further comprise selecting a spatial size of the image data of the scene which is to be provided by the second subset of streams based on at least one of:
a measurement or statistics of head movement of a user;
a measurement or statistics of head rotation of a user;
a type of content represented by the VR video;
a transmission delay in the network between the one or more stream sources and the network cache;
a transmission delay in the network between the network cache and the VR rendering device; and
a processing delay of a processing of the first subset of streams by the VR rendering device.

It may be desirable to avoid unnecessarily caching streams in the network cache, e.g., so as to avoid unnecessary allocation bandwidth and/or data storage. At the same time, it may be desirable to retain a high cache hit ratio. To obtain a compromise between both aspects, the spatial size of the image data which is cached, and thereby the number of streams which are cached, may be dynamically adjusted based on any number of the above measurements, estimates or other type of data. Namely, the above data may be indicative of how large the change in view may be with respect to the view rendered on the basis of the first subset of streams, and thus how large the ‘guard band’ which is cached in the network cache may need to be. This may have as advantage that the caching is more effective, e.g., as measured as the cache hit ratio relative to the number of streams being cached, and/or the cache hit ratio relative to the allocation of bandwidth and/or data storage used for caching.

It is noted that the term ‘spatial size’ may indicate a spatial extent of the image data, e.g., with respect to the canvas of the VR video. For example, the spatial size may refer to a horizontal and vertical size of the image data in pixels. Other measures of spatial size are equally possible, e.g., in terms of degrees, etc.

In an embodiment, the second subset of streams may be accessible at the one or more stream sources at different quality levels, and the method may further comprise selecting a quality level at which the second subset of streams is to be cached based on at least one of:
an available bandwidth in the network between the one or more stream sources and the network cache;
an available bandwidth in the network between the network cache and the VR rendering device; and
a spatial size of the image data of the scene which is to be provided by the second subset of streams.

It is known to make streams accessible at different quality levels, e.g., from the adaptive bitrate streaming including but not limited to MPEG Dynamic Adaptive Streaming over HTTP (MPEG-DASH). The quality level may be proportionate to the bandwidth and/or data storage required for caching the second subset of streams. As such, the quality level may be dynamically adjusted based on any number of the above measurements, estimates or other types of data. This may have as advantageous effect that the available bandwidth towards and/or from the network cache, and/or the data storage in the network cache, may be more optimally allocated, e.g., yielding a higher quality if sufficient bandwidth and/or data storage is available.

In an embodiment, the method may further comprise:
receiving a request from the VR rendering device for streaming of the first subset of streams;
identifying the first subset of streams on the basis of the request.

It may be needed to first identify which streams are currently streaming to the VR rendering device, or are about to be streamed, so to be able to identify which second subset of streams is to be cached in the network cache. The first subset of streams may be efficiently identified based on a request from the VR rendering device for the streaming of said streams. The request may be intercepted by, forwarded to, or directly received from the VR rendering device by the network entity performing the method, e.g., the network cache, a stream source, etc. An advantageous effect may be that an accurate identification of the first subset of streams is obtained. As such, it may not be needed to estimate which streams are currently streaming to the VR rendering device, or are about to be streamed, which may be less accurate.

In an embodiment, the method may further comprise, in response to the receiving of the request:
if available, effecting a delivery of one or more streams of the first subset of streams from the network cache; and
for one or more other streams of the first subset of streams which are not available from the network cache,
   jointly requesting the one or more other streams with the second subset of streams from the one or more stream sources,
   effecting a delivery of the one or more other streams to the VR rendering device, while effecting the caching of the second subset of streams in the network cache.

The selection of streams to be cached may be performed on a continuous basis. As such, for an initial request of the VR rendering device for a first subset of streams, the first subset of streams and a ‘guard band’ in the form of a second subset of streams may be requested from the one or more stream sources, with the second subset of streams being cached in the network cache and the first subset of streams being delivered to the VR rendering device for rendering. For following request(s) of the VR rendering device, the requested stream(s) may then be delivered from the network cache if available, and if not available, may be requested together with the new or updated ‘guard band’ of streams and delivered to the VR rendering device.

In an embodiment, the stream metadata may be a manifest such as a media presentation description. For example, the manifest may be a MPEG-DASH Media Presentation Description (MPD) or similar type of structured document.

In an embodiment, the method may be performed by the network cache or the one or more stream sources.

In an embodiment, the effecting the caching of the second subset of streams may comprise sending a message to the network cache or the one or more stream sources comprising instructions to cache the second subset of streams in the network cache. For example, in an embodiment, the method may be performed by the VR rendering device, which may then effect the caching by sending said message.

In an embodiment, the VR rendering device may be a MPEG Dynamic Adaptive Streaming over HTTP [DASH] client, and the message may be a Server and Network Assisted DASH [SAND] message to a DASH Aware Network Element [DANE], such as but not limited to an ‘Anticipated Requests’ message.

It will be appreciated that the scene represented by the VR video may be an actual scene, which may be recorded by one or more cameras. However, the scene may also be a rendered scene, e.g., obtained from computer graphics rendering of a model, or comprise a combination of both recorded parts and rendered parts

It will be appreciated by those skilled in the art that two or more of the above-mentioned embodiments, implementations, and/or aspects of the invention may be combined in any way deemed useful.

Modifications and variations of the VR rendering device, the network cache, the one or more stream sources and/or the computer program, which correspond to the described modifications and variations of the method, and vice versa, can be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a plurality of streams representing a VR video;

FIG. 2 shows another plurality of streams representing another VR video;

FIG. 3 illustrates the streaming of a VR video from a server to a VR rendering device in accordance with one aspect of the invention;

FIG. 4 shows a tile-based representation of a VR video, while showing a current viewport of the VR device which comprises a first subset of tiles;

FIG. 5 shows a second subset of tiles which is selected to be cached, with the second subset of tiles providing a guard band for the current viewport;

FIG. 6 shows a message exchange between a client, a cache and a server, in which streams, which are predicted to be requested by the client, are cached;

FIG. 7 illustrates the predictive caching of streams within the context of a pyramidal encoded VR video, in which different streams each show a different part of the scene in higher quality while showing the remainder in lower quality;

FIG. 8 shows a message exchange between a client, a cache and a server in which streams are cached by the cache within the context of multicasting;

FIG. 9 shows an MPEG DASH embodiment in which a cache predicts and caches streams which provide a guard band for the current viewport;

FIG. 10 shows an MPEG DASH embodiment in which Server and network assisted DASH (SAND) is used by the DASH client to indicate to a DASH Aware Network Element (DANE) which streams it expects to request in the future;

FIG. 11 shows another MPEG DASH embodiment using SAND in which the DASH client indicates to the server which streams it expects to request in the future;

FIG. 12 illustrates the SAND concept of ‘AcceptedAlternatives’;

FIG. 13 illustrates the simultaneous tile-based streaming of a VR video to multiple VR devices which each have a different, yet potentially overlapping viewport;

FIG. 14 shows the guard bands which are to be cached for each of the VR devices, illustrating that overlapping tiles only have to be cached once;

FIG. 15 shows an example of the selective caching of parts of a content timeline of streams within the context of tiled streaming;

FIG. 16 shows a variant of the example of FIG. 15 in which the client requests new tiles before the tiles of a previous guard band are delivered;

FIG. 17 shows a variant of the example of FIG. 15 in which the request of the client is a first request, e.g., before caching of tiles has commenced;

FIG. 18 shows an exemplary network cache;

FIG. 19 shows an exemplary VR rendering device;

FIG. 20 shows a method for streaming a VR video to a VR rendering device;

FIG. 21 shows a transitory or non-transitory computer-readable medium which may comprise computer program comprising instructions for a processor system to perform the method, or spatial relation data, or stream metadata; and

FIG. 22 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### LIST OF REFERENCE AND ABBREVIATIONS

The following list of references and abbreviations is provided for facilitating the interpretation of the drawings and shall not be construed as limiting the claims.
DANE DASH Aware Network Element
DASH Dynamic Adaptive Streaming over HTTP
MPD Media Presentation Description
NAL Network Abstraction Layer
PES Packetised Elementary Stream
PIDPacket Identification
SAND Server and Network Assisted DASH
SRD Spatial Relationship Description
TS Transport Stream
VR Virtual Reality
10, 20 plurality of streams
22 first subset of streams
24 second subset of streams
30 access network
40 core network
100 VR rendering device
102″ request stream B″ data communication
110 network cache
112″ delivery stream B″ data communication
114″ request stream A, C″ data communication
120 server
122″send stream A, C″ data communication
200 tile-based representation of VR video
210-212 tiles of current viewport
220-222 tiles of guard band for current viewport
230-234 pyramidal encoding of VR video
240-244 higher resolution viewport in pyramidal encoding
300 network cache
310 network interface
320 cache controller
330 data storage
400 VR rendering device
410 network interface
420 display processor
430 controller
500 method of streaming VR video to VR rendering device
510 obtaining spatial relation data
520 identifying needed stream(s)
530 identifying guard band stream(s)
540 obtaining stream metadata
550 effecting caching of guard band stream(s)
600 computer readable medium
610 data stored on computer readable medium
1000 exemplary data processing system
1002 processor
1004 memory element
1006 system bus
1008 local memory
1010 bulk storage device
1012 input device
1014 output device
1016 network adapter
1018 application

### DETAILED DESCRIPTION OF EMBODIMENTS

The following describes several embodiments of streaming a VR video to a VR rendering device. The VR video may be represented by a plurality of streams each providing different image data of a scene. The embodiments involve the VR rendering device rendering, or seeking to render, a selected view of a scene on the basis of a first subset of a plurality of streams. In response, a second subset of streams which provides spatially adjacent image data may be cached in a network cache.

In the following, the VR rendering device may simply be referred to as ‘receiver’ or ‘client’, a stream source may simply be referred to as ‘server’ or ‘delivery node’ and a network cache may simply be referred to as ‘cache’ or ‘delivery node’.

The image data representing the VR video may be 2D image data, in that the canvas of the VR video may be represented by a 2D region of pixels, with each stream representing a different sub-region or different representation of the 2D region. However, this is not a limitation, in that for example the image data may also represent a 3D volume of voxels, with each stream representing a different sub-volume or different representation of the 3D volume. Another example is that the image data may be stereoscopic image data, e.g., by being comprised of two or more 2D regions of pixels or by a 2D region of pixels which is accompanied by a depth or disparity map.

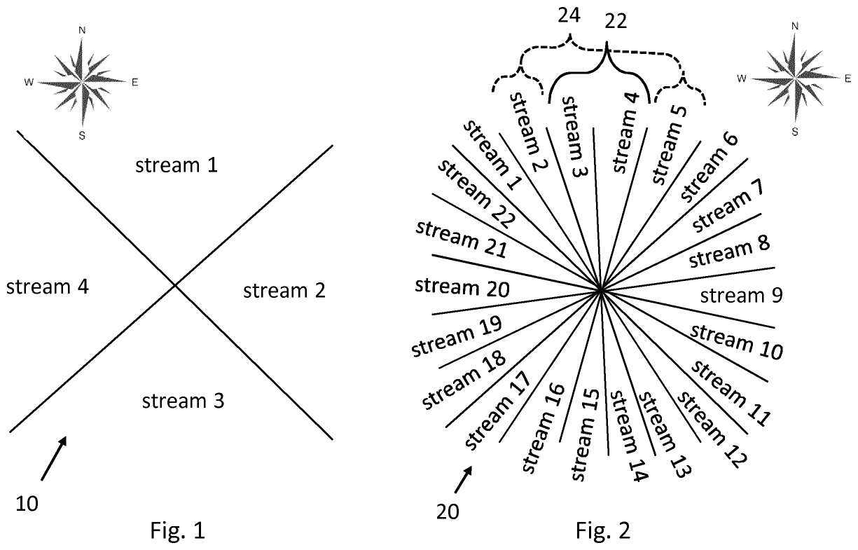

As illustrated in FIGS. 1 and 2, the VR video may be streamed using a plurality of different streams 10, 20 to provide a panoramic or omnidirectional, spherical view from a certain viewpoint, e.g., that of the user in the VR environment. In the examples of FIGS. 1 and 2, the panoramic view is shown to be a complete 360 degree view, which is shown in FIG. 1 to be divided into 4 sections corresponding to the cardinal directions N, E, S, W, with each section being represented by a certain stream (e.g., north=stream 1, east=stream 2, etc.). As such, in order for the VR rendering device to render a view in a north-facing direction, stream 1 may be needed. If the user turns east, the VR rendering device may have to switch from stream 1 to stream 2 to render a view in an east-facing direction.

In practice, it has been found that users do not instantaneously turn their head, e.g., by 90 degrees. As such, it may be desirable for streams to spatially overlap, or a view to be rendered from multiple streams or segments which each represent a smaller portion of the entire panoramic view. For example, as shown in FIG. 2, the VR rendering device may render a view in the north-facing direction based on streams 1, 2, 3, 4, 5 and 6. When the user turns his/her head east, stream 7 may be added and stream 1 removed, then stream 8 may be added and stream 2 may be removed, etc. As such, in response to a head rotation or other type of change in viewpoint, a different subset of streams may be needed. Here, the term ‘subset’ refers to ‘one or more’ streams. It will be appreciated that subsets may overlap, e.g., as in the example of FIG. 2, where in response to a user's head rotation the VR rendering device may switch from the subset of streams {1, 2, 3, 4, 5, 6} to a different subset {2, 3, 4, 5, 6, 7}.

By way of example, the aforementioned first subset of streams 22 is shown in FIG. 2 to comprise stream 3 and 4. The second subset of streams 24 is shown in FIG. 2 to comprise stream 2 and stream 5, providing spatially adjacent image data.

It will be appreciated that, although not shown in FIGS. 1 and 2, the VR video may include streams which show views above and below the user. Moreover, although FIGS. 1 and 2 each show a 360 degree panoramic video, the VR video may also represent a more limited panoramic view, e.g., 180 degrees. Furthermore, the streams may, but do not need to, partially or entirely overlap. An example of the former is the use of small guard bands, e.g., having a size less than half the size of the image data of a single stream. An example of the latter is that each stream may comprise the entire 360 degree view in low resolution, while each comprising a different and limited part of the 360 degree view, e.g., a 20 degree view, in higher resolution. The lower resolution parts may be located to the left and right of the higher resolution view, but also above and/or below said higher resolution view. The different parts may be of various shapes, e.g., rectangles, triangles, circles, hexagons, etc.

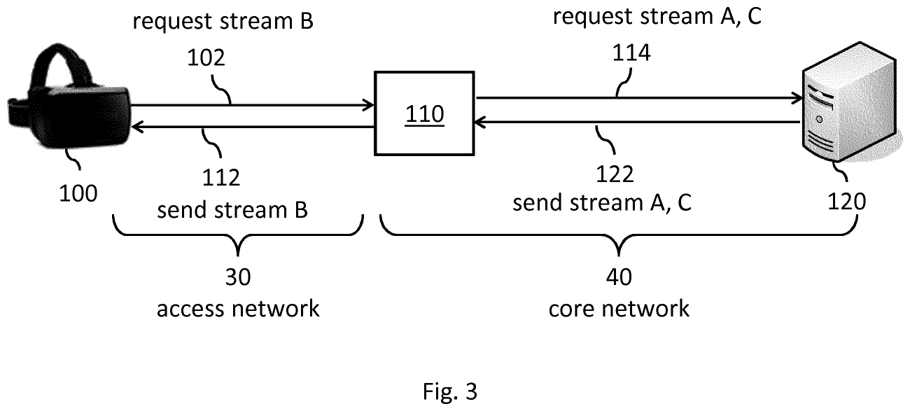

FIG. 3 illustrates the streaming of VR video from a server 120 to a VR rendering device 100 in accordance with one aspect of the invention. As shown in FIG. 3, a VR rendering device 100 may request a stream B by way of data communication ‘request stream B’ 102. The request may be received by a network cache 110. In response, the network cache 110 may start streaming stream B to the VR rendering device by way of data communication ‘send stream B’ 112. At substantially the same time, the network cache 110 may request streams A and C from a server 120 by way of data communication ‘request stream A, C’ 114. Streams A and C may represent image data which is spatially adjacent to the image data provided by stream B. In response, the server 120 may start streaming streams A and C to the network cache 110 by way of data communication ‘send stream A, C’ 122. The data of the streams A and C may then be stored in a data storage of the network cache 110 (not shown in FIG. 3). Note that also stream B may be requested from the server 120 (not shown here for reasons of brevity), namely to be able to deliver this stream B from the network cache 110 for subsequent requests of VR rendering device 100 or other VR rendering devices.

If the VR rendering device 100 subsequently requests stream A and/or C, either or both of said streams may then be delivered directly from the network cache 110 to the VR rendering device 100, e.g., in a similar manner as previously stream B.

As also shown in FIG. 3, the network cache 110 may be positioned at an edge between a core network 40 and an access network 30 via which the VR rendering device 100 may be connected to the core network 40. The core network 40 may comprise, or be constituted by the internet. The access network 30 may be bandwidth constrained compared to the core network 40. However, these are not limitations, as in general, the network cache 110 may be located upstream of the VR rendering device 100 and downstream of the server 120 in a network, with ‘network’ including a combination of several networks, e.g., the access network 30 and core network 40.

Tiled/Segmented Streaming

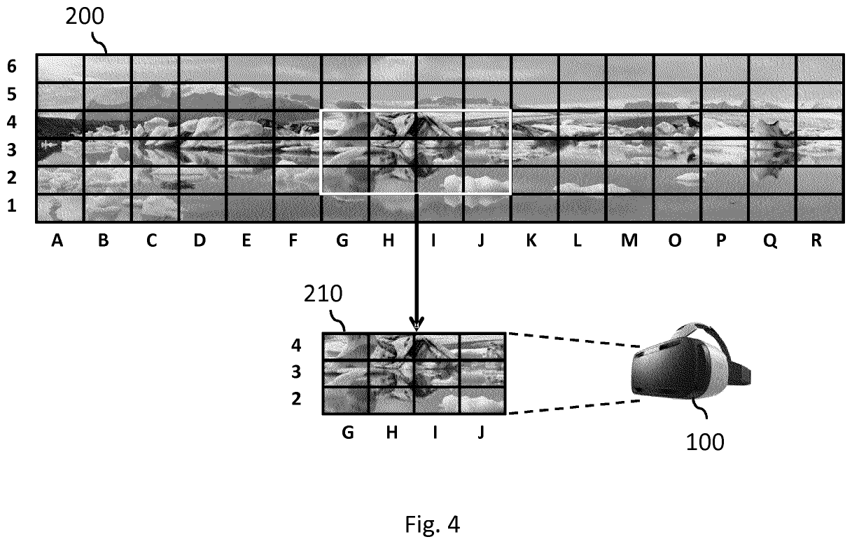

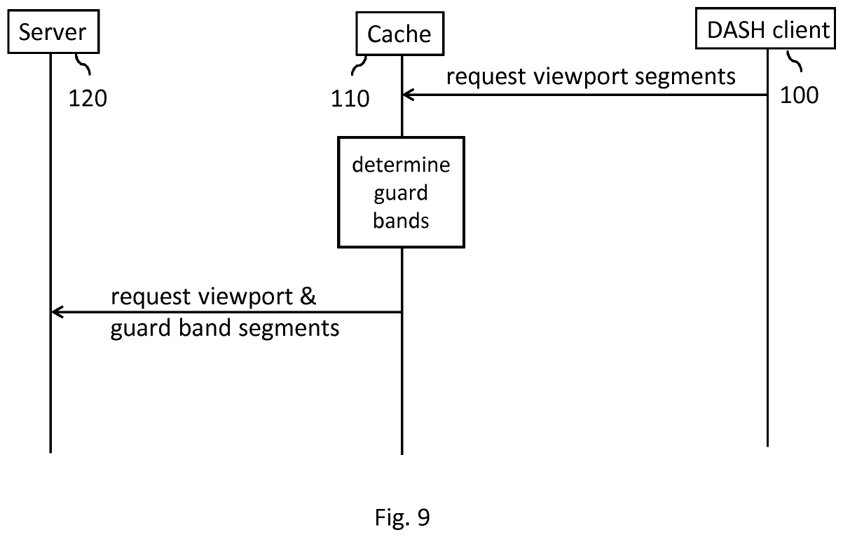

MPEG DASH and tiled streaming is known in the art, e.g., from Ochi, Daisuke, et al. “Live streaming system for omnidirectional video” Virtual Reality (VR), 2015 IEEE. Briefly speaking, using a Spatial Relationship Description (SRD), it is possible to describe the relationship between tiles in an MPD (Media Presentation Description). Tiles may then be requested individually, and thus any particular viewport may be requested by a client, e.g., a VR rendering device, by requesting the tiles needed for the viewport. In the same way, guard band tiles may be requested by the cache, which is described in the following with reference to FIGS. 4-6. It is noted that additional aspects relating to tiled streaming are described with reference to FIG. 9.

FIG. 4 shows a tile-based representation 200 of a VR video, while showing a current viewport 210 of the VR device 100 which comprises a first subset of tiles. In the depiction of the tile-based representation 200 of the VR video and the current viewport 210, a coordinate system is used to indicate the spatial relationship between tiles, e.g., using a horizontal axis from A-R and a vertical axis from 1-6. It is noted that in this and following examples, for ease of explanation, the current viewport 210 is shown to be positioned such that it is constituted by a number of complete tiles, e.g., by being perfectly aligned with the grid of the tiles 200. Typically, however, the current viewport 210 may be positioned such that it comprises one or more partial tiles, e.g., by being misaligned with respect to the grid of the tiles 200. Effectively, the current viewport 210 may represent a crop of the image data of the retrieved tiles. A partial tile may nevertheless need to be retrieved in its entirety. It is noted that the selection of tiles for the current viewport may be performed in a manner known per se in the art, e.g., in response to a head tracking, as also elsewhere described in this specification.

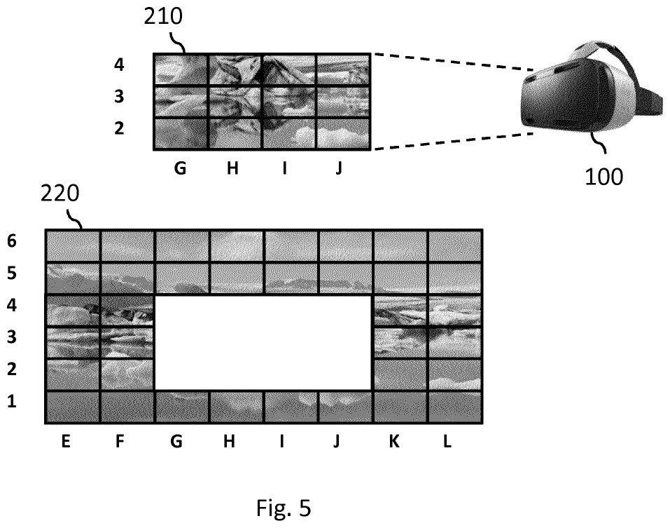

FIG. 5 shows a guard band for the current viewport 210. Namely, a set of tiles 220 is shown which surround the current viewport 210 and thereby provide spatially adjacent image data for the image data of the tiles of the current viewport 210.

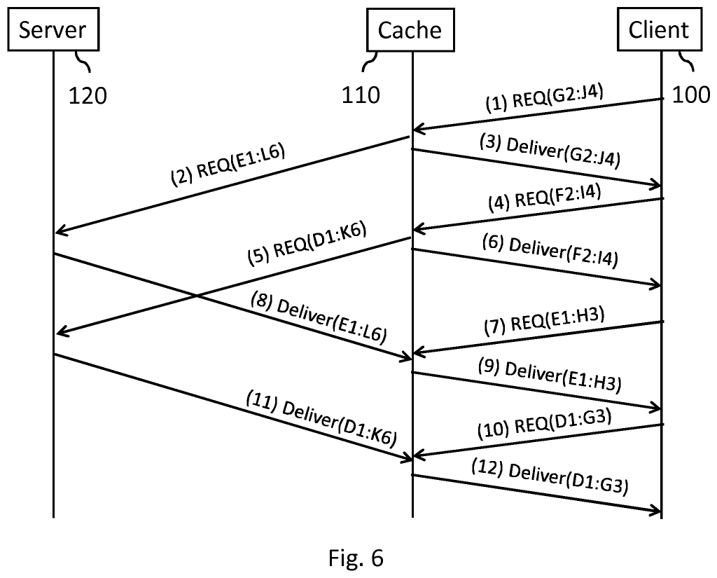

The caching of such a guard band 220 is explained with further reference, to FIG. 6, which shows a message exchange between a client 100, e.g., the VR rendering device, a cache 110 and a server 120. Here, reference is made to segments, representing the video of a tile for a part of the content timeline of the VR video.

The client 100 firstly request segments G2:J4 by way of message (1). The cache 110 then request segments E1:L6, which may represent a combination of a viewport and accompanying guard band for segments G2:J4, by way of message (2). The cache 110 further delivers the requested segments G2:J4 by way of message (3). It is noted that segments G2:J4 may have been cached in response to a previous request, which is not shown here. Next, the client 100 requests tiles F2:I4 by way of message (4), e.g., in response to the user turning his/her head to the left, and the cache 110 again requests a combination of a viewport and guard band D1:K6 by way of message (5) while delivering the requested segments F2:I4 by way of message (6). The client 100 then requests tiles E1:H3 by way of message (7), e.g., in response to the user turning his/her head more to the left and a bit downwards. Now, the cache 110 receives the segments E1:L6 from the earlier request (1). Thereby, the cache 110 is able to deliver segments E1:H3 as requested, namely by way of message (9). Messages (10)-(12) represent a further continuation of the message exchange.

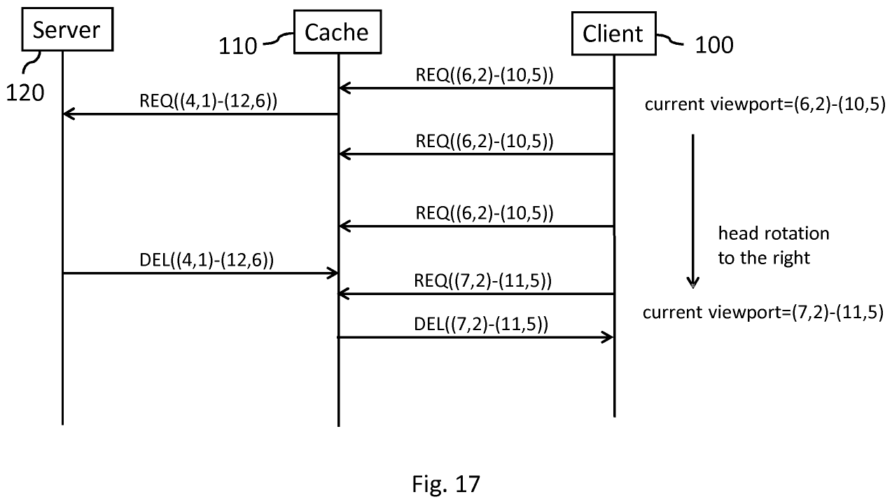

In this respect, it is noted that when initializing the streaming of the VR video, the first segment (or first few segments) that are requested by the client may not immediately be available from the cache, as these segments may need to be retrieved from the media server first. To bridge the gap between this initialization period, in which segments may be received after a potentially sizable delay, and the ongoing streaming session, in which segments may be previously cached and thus delivered quickly from the cache, the client may either temporarily skip play-out of segments or temporarily increase its playout speed. If segments are skipped, and if message (1) of FIG. 6 is the first request in the initialization period, then message (9) may be the first delivery that can be made by the cache 110. The segments of messages (3) and (6) may not be delivered quickly, and may thus be skipped in the play-out by the client 100. It is noted that the initialization aspect is further described with reference to FIG. 17. It should also be appreciated in the above and other embodiments, that a request for a combination of a viewport and guard band(s) may comprise separate requests for separate tiles. For example the viewport tiles may be requested before the guard band tiles, e.g. to increase the probability that at least the viewport is available at the cache in time, or to allow a fraction of a second for calculating the optimal guard band before requesting the guard band tiles.

Pyramidal Encoding

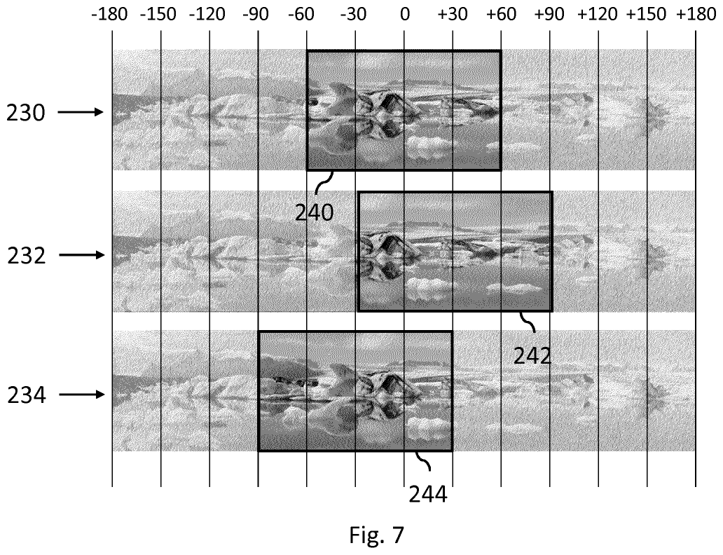

FIG. 7 illustrates the predictive caching of streams within the context of a pyramidal encoded VR video, in which different streams each show a different part of the scene in higher quality while showing the remainder in lower quality. Such pyramidal encoding is described, e.g., in Kuzyakov et al., “Next-generation video encoding techniques for 360 video and VR”, 21 Jan. 2016, web post found at https://code.facebook.com/posts/1126354007399553/next-generation-video-encoding-techniques-for-360-video-and-vr/. As such, the entire canvas of the VR video may be encoded multiple times, with each encoded stream comprising a different part in higher quality and the remainder in lower quality, e.g., with lower bitrate, resolution, etc. Although shown as rectangles in FIG. 7, it will be appreciated that the different parts may be of various shapes, e.g., triangles, circles, hexagons, etc.

For example, a 360 degree panorama may be portioned in 30 degree slices and may be encoded 12 times, each time encoding four 30 degree slices together, e.g., representing a 120 degree viewport, in higher quality. This 120 degree viewport may match the 100 to 110 degree field of view of current generation VR headsets. An example of three of such encodings is shown in FIG. 7, showing a first encoding 230 having a higher quality viewport 240 from −60 to +60 degrees, a second encoding 232 having a higher quality viewport 242 from −30 to +90 degrees, and a third encoding 234 having a higher quality viewport 244 from −90 to +30 degrees. In a specific example, the current viewport may be [−50:50], which may fall well within the [−60:60] encoding 230. However, when the user moves his/her head to the right or the left, the viewport may quickly move out of the high quality region of the encoding 230. As such, as ‘guard bands’, the [−30:90] encoding 232 and to the [−90:30] encoding 234 may be cached by the cache, thereby allowing the client to quickly switch to another encoding.

Such encodings may be delivered to a client using multicast. Multicast streams may be set up to the edge of the network, e.g., in dense-mode, or may be only sent upon request, e.g., in sparse-mode. When the client requests a certain viewport, e.g., by requesting a certain encoding, the encoding providing higher quality to the right and to the left of the current viewport may also be sent to the edge. The table below shows example ranges and the multicast address for that specific stream/encoding.

| | Multicast |
|---|---|
| Range | address |
| [−180:−60] | 225.1.1.6 |
| [−150:−30] | 225.1.1.7 |
| [−120:0] | 225.1.1.8 |
| [−90:+30] | 225.1.1.9 |
| [−60:+60] | 225.1.1.10 |
| [−30:+90] | 225.1.1.11 |
| [0:+120] | 225.1.1.12 |
| [+30:+150] | 225.1.1.13 |
| [+60:+180] | 225.1.1.14 |
| [+90:−30] | 225.1.1.15 |
| [+120:−60] | 225.1.1.16 |
| [+150:−90] | 225.1.1.17 |

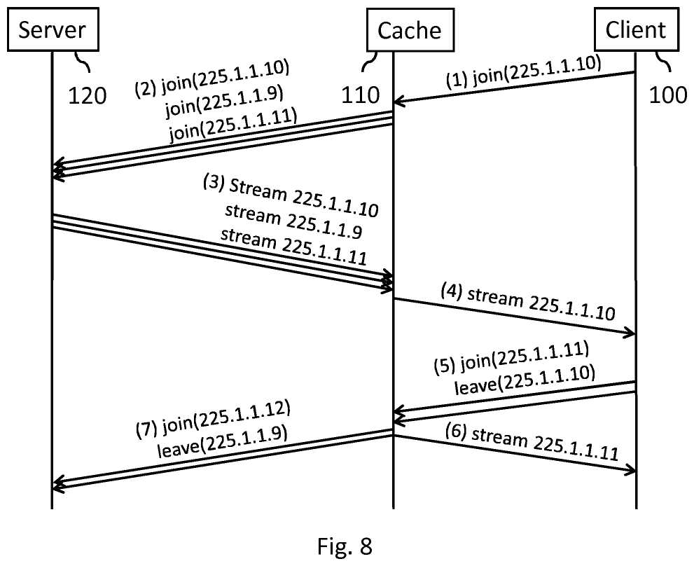

FIG. 8 shows a corresponding message exchange between a client 100, a cache 110 and a server 120 in which streams are cached by the cache 110 within the context of multicasting. In this specific example, the client 100 first requests the 225.1.1.10 stream by joining this multicast via a message (1), e.g., with an IGMP join. The cache 110 then not only requests this stream from the server 120, but also the adjacent streams 225.1.1.9 and 225.1.1.10 by way of message (2) (or possibly multiple messages, one per multicast address). Once the streams are delivered by the server 120 to the cache 110 by way of message (3), the cache 110 delivers only the requested 225.1.1.10 stream to the client 100 by way of message (4). If the user then turns his head to the right, the client 100 may join the 225.1.1.11 stream and leave the 225.1.1.10 stream via message (4). As the 225.1.1.11 stream is available at the cache 110, it can be quickly delivered to the client 100 via message (6). The cache 110 may subsequently leave the no-longer-adjacent stream 225.1.1.9 and join the now-adjacent stream 225.1.1.12 via message (7) to update the caching. It will be appreciated that although the join and leave are shown as single messages in FIG. 8, e.g., as allowed by IGMP version 3, such join/leave messages may also be separate messages.

In this example, the entire encoding or stream is switched. To enable this to occur quickly, it is desirable for each new stream to start with an I-frame. Techniques for doing so are described and/or referenced elsewhere in this specification.

Cloud-Based FoV Rendering

An alternative to tiled/segmented streaming and pyramidal encoding is cloud-based Field of View (FoV) rendering, e.g., as described in Steglich et al., “360 Video Experience on TV Devices”, presentation at EBU Broad Thinking 2016, 7 Apr. 2016. Also in this context, the described caching mechanism may be used. Namely, instead of only cropping the VR video, e.g., the entire 360 degree panorama, to the current viewport, also additional viewports may be cropped which may have a spatial offset with respect to the current viewport. The additional viewports may then be encoded and delivered to the cache, while the current viewport may be encoded and delivered to the client. Here, the spatial offset may be chosen such that it comprises image data which is likely to be requested in the future. As such, the spatial offset may result in an overlap between viewports if head rotation is expected to be limited.

MPEG DASH

With further reference to the caching within the context of MPEG DASH, FIG. 9 shows a general MPEG DASH embodiment in which a cache 110 predicts and caches streams which provide a guard band for the current viewport. As such, the cache 110 may be media aware. In general, the cache 110 may use the same mechanism as the client 100 to request the appropriate tiles. For example, the cache 110 may have access to the MPD describing the content, e.g., the VR video, and be able to parse the MPD. The cache 100 may also be configured with a ruleset to derive the guard bands based on the tiles requested by the client 100. This may be a simple ruleset, e.g., two tiles guard bands in all directions, but may also be more advanced. For example, the ruleset may include movement prediction: a client requesting tiles successively to the right may be an indication of a right-rotation of the user. Thus, guard bands even more to the right may be cached while caching fewer to the left. Also, in case of a lack of movement, e.g., for a prolonged period, the guard bands may be decreased in size, while their size may be increased with significant movement. This aspect is also further onwards described with reference to ‘Guard band size’.

In general, in order to identify which streams are to be cached, spatial relation data may be needed which is indicative of a spatial relation between the different image data of the scene as provided by the plurality of streams. With continued reference to MPEG-DASH, the concept of tiles may be implemented by the Spatial Relationship Description (SRD), as described in ISO/IEC 23009-1:2015/FDAM 2:2015(E) (at the time of filing only available in draft). Such SRD data may be an example of the spatial relation data. Namely, DASH allows for different adaptation sets to carry different content, for example various camera angles or in case of VR various tiles together forming a 360 degree video. The SRD may be an additional property for an adaptation set that may describe the width and height of the entire content, e.g., the complete canvas, the coordinates of the upper left corner of a tile and the width and height of a tile. Accordingly, each tile may be individually identified and separately requested by a DASH client supporting the SRD mechanism. The following table provides an example of the SPD data of a particular tile of the VR video:

| Property | Property | |
|---|---|---|
| name | value | Comments |
| source_id | 0 | Unique identifier for the source of the |
| | | content, to show what content the spatial |
| | | part belong to |
| object_x | 6 | x-coordinate of the upper-left corner of |
| | | the tile |
| object_y | 2 | y-coordinate of the upper-left corner of |
| | | the tile |
| object_width | 1 | Width of the tile |
| object_height | 1 | Height of the tile |
| total_width | 17 | Total width of the content |
| total_height | 6 | Total height of the content |

In this respect, it is noted that the height and width may be defined on an (arbitrary) scale that is defined by the total height and width chosen for the content.

The following provides an example of a Media Presentation Description which references to the tiles. Here, first the entire VR video is described, with the SRD having been added in comma separated value pairs. The entire canvas is described, where the upper left corner is (0,0), the size of the tile is (17,6) and the size of the total content is also (17,6). Afterwards, the first four tiles (horizontally) are described.

```
<?xml version=″1.0″ encoding=″UTF-8″?>
<MPD
  xmlns=″urn:mpeg:dash:schema:mpd:2011″
  type=static″
  mediaPresentationDuration=″PT10S″
  minBufferTime=″PT1S″
  profiles='urn:mpeg:dash:profile:isoff-on-demand:2011″>
  <ProgramInformation>
    <Title>Example of a DASH Media Presentation Description using Spatial Relationship
Description to indicate tiles of a video</Title>
  </ProgramInformation>
  <Period>
    <!-- Main Video -->
    <AdaptationSet segmentAlignment=″true″ subsegmentAlignment=″true″
subsegmentStartsWithSAP=″1″>
      <Role schemeIdUri=″urn:mpeg:dash:role:2011″ value=″main″/>
      <SupplementalProperty schemeIdUri=″urn:mpeg:dash:srd:2014″ value=″0,0,0,17,6,17,6″/>
      <Representation mimeType=″video/mp4″ codecs=″avc1.42c01e″ width=″640″ height=″360″
bandwidth=″226597″ startWithSAP=″1″>
        <BaseURL> full_video_small.mp4</BaseURL>
        <SegmentBase indexRangeExact:″true″ indexRange″837-988″/>
      </Representation>
      <Representation mimeType=″video/mp4″ codecs″avc1.42c01f″ width=″1280″ height=″720″
bandwidth=″553833″ startWithSAP″1″>
        <BaseURL> full_video_hd.mp4</BaseURL>
        <SegmentBase indexRangeExact=″true″ indexRange=″838-989″/>
      </Representation>
      <Representation mimeType=″video/mp4″ codecs=″avc1.42g033″ width=3840″
height=″2160″ bandwidth=″1055223″ startWithSAP=″1″>
        <BaseURL> full_video_4k.mp4</BaseURL>
        <SegmentBase indexRangeExact=″true″ indexRange=″839-990″/>
      </Representation>
    </AdaptationSet>
    <!-- Tile 1 -->
    <AdaptationSet segmentAlignment=″true″ subsegmentAlignment=″true″
subsegmentStartsWithSAP=″1″>
      <Role schemeIdUri=″urn:mpeg:dash:role:2011″ value=″supplementary″/>
      <SupplementalProperty schemeIdUri=″urn:mpeg:dash:srd:2014″ value=″0,0,0,1,1,17,6″/>
      <Representation mimeType=″video/mp4″ codecs=″avc1.42c00d″ width=″640″ height=″360″
bandwidth=″218284″ startWithSAP=″1″>
        <BaseURL> tile1_video_small.mp4</BaseURL>
        <SegmentBase indexRangeExact=″true″ indexRange=″837-988″/>
      </Representation>
      <Representation mimeType=″video/mp4″ codecs=″avc1.42c01f″ width=″1280″ height=″720″
bandwidth=″525609″ startWithSAP=″1″>
        <BaseURL> tile1_video_hd.mp4</BaseURL>
        <SegmentBase indexRangeExact=″true″ indexRange=″838-989″/>
      </Representation>
      <Representation mimeType=″video/mp4″ codecs=″avc1.42c028″ width= ″1920″
height=″1080″ bandwidth=″769514″ startWithSAP=″1″>
        <BaseURL> tile1_video_fullhd.mp4</BaseURL>
        <SegmentBase indexRangeExact=″true″ indexRange=″839-990″/>
      </Representation>
    </AdaptationSet>
    <!-- Tile 2 -->
    <AdaptationSet segmentAlignment=″true″ subsegmentAlignment=″true″
subsegmentStartsWithSAP=″1″>
      <SupplementalProperty schemeIdUri=″urn:mpeg:dash:srd:2014″ value=″0,1,0,1,1,17,6″/>
...
    </AdaptationSet>
    <!-- Tile 3 -->
    <AdaptationSet segmentAlignment=″true″ subsegmentAlignment=″true″
subsegmentStartsWithSAP=″1″>
      <SupplementalProperty schemeIdUri=″urn:mpeg:dash:srd:2014″ value=″0,2,0,1,1,17,6/>
...
    </AdaptationSet>
    <!-- Tile 4 -->
    <AdaptationSet segmentAlignment=″true″ subsegmentAlignment=″true″
subsegmentStartsWithSAP=″1″>
      <SupplementalProperty schemeIdUri=″urn:mpeg:dash:srd:2014″ value=″0,3,0,1,1,17,6″/>
...
    </AdaptationSet>
...
  </Period>
</MPD>
```

It will be appreciated that various other ways of describing parts of a VR video in the form of spatial relation data are also conceivable. For example, spatial relation data may describe the format of the video (e.g., equirectangular, cylindrical, unfolded cubic map, cubic map), the yaw (e.g., degrees on the horizon, from 0 to 360) and the pitch (e.g., from −90 degree (downward) to 90 degree (upward). These coordinates may refer to the center of a tile, and the tile width and height may be described in degrees. Such spatial relation data would allow for easier conversion from actual tracking data of a head tracker, which is also defined on these axis.

Server and Network Assisted DASH

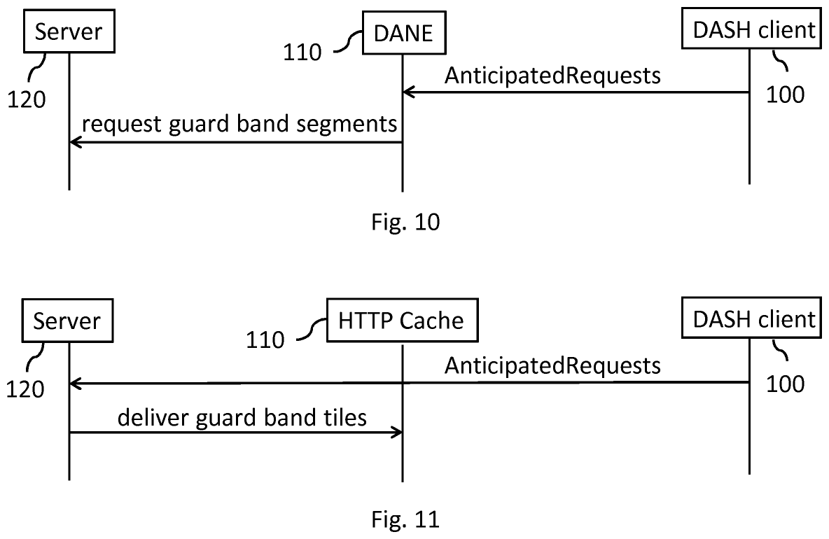

FIG. 10 shows an MPEG DASH embodiment using the DASH specification Server and network assisted DASH (SAND), as described in ISO/IEC DIS 23009-5. This standard describes signalling between a DASH client and a DASH Aware Network Element (DANE), such as a DASH Aware cache (with such a cache being in the following simply referred to as DANE). The standard allows for the following:

1. The DASH client may indicate to the DANE what it anticipates to be future requests. Using this mechanism, the client may thus indicate the guard band tiles as possible future requests, allowing the DANE to retrieve these in advance.

2. The DASH client may also indicate acceptable representations of the same adaptation set, e.g., indicate acceptable resolutions and content bandwidths. This allows the DANE to make decisions on which version to actually provide. In this way, the DANE may retrieve lower-resolution (and hence lower-bandwidth versions), depending on available bandwidth. The client may always request the high resolution version, but may be told that the tiles delivered are actually a lower resolution.

With further reference to the first aspect, the indication of anticipated requests may be done by the DASH client 100 by sending the status message AnticipatedRequests to the DANE 110 as shown in FIG. 10. This request may comprise an array of segment URLs. For each URL, a byte range may be specified and an expected request time, or targetTime, may be indicated. This expected request time may be used to determine the size of the guard band: if a request is anticipated later, then it may be further away from the current viewport and thus a larger guard band may be needed. Also, if there is slow head movement or fast head movement, expected request times may be later or earlier, respectively. If the DASH client indicates these anticipated requests, the DANE may request the tiles in advance and have them cached by the time the actual requests are sent by the DASH client.

It is noted that if the DASH client indicates that it expects to request a certain spatial region in 400 ms, this may denote that the DASH client will request tiles from the content that is playing at that time. The expected request time may thus indicate which part of the content timeline of a stream is to be cached, e.g., which segment of a segmented stream. The following is an example of (this part of) a status message sent in HTTP headers, showing an anticipated request for tile 1:

SAND-AnticipatedRequests: [sourceURL=″http://my.cdn.com/video/
tile1_video_fullhd.mp4″,range=989-1140,targetTime=2015-10-11T17:53:03Z]

FIG. 11 shows another MPEG DASH embodiment using SAND in which the server 120 is a DANE, while the cache 110 is a regular HTTP cache rather than a media aware, ‘intelligent’ cache. In this example, the client 100 may send AnticipatedRequests messages to the server 120 indicating the guard bands. To enable the guard bands to be cached, the server 120 may need to be aware of the cache being used by the client. This is possible, but depends on the mechanisms used for request routing, e.g., as described in Bartolini et al. “A walk through content delivery networks”, Performance Tools and Applications to Networked Systems, Springer Berlin Heidelberg, 2004. In general, in a Content Delivery Network (CDN), it is assumed that the CDN knows which clients are redirected to which cache. Also, the CDN is expected to have distribution mechanisms to fill the caches with the appropriate content, which in case of DASH may comprise copying the proper DASH segments to the proper caches.

However, the client 100 may still need to be told where to send its AnticipatedRequest messages. This may be done with the SAND mechanism to signal the SAND communication channel to the client 100, as described in the SAND specification. This mechanism allows to signal multiple DANE addresses to the client 100, but currently does not allow for signalling of which type of requests should be sent to which DANE. The signalling about the SAND communication channel may be extended to include a parameter ‘SupportedMessages’, which may be an array of supported message types. This additional parameter would allow for signalling to the client 100 which types of requests should be sent to which DANE.

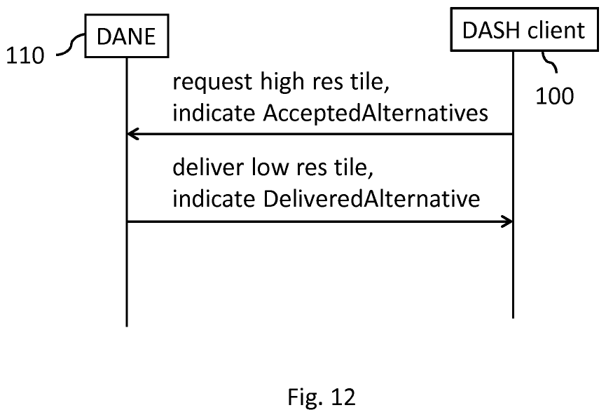

With further reference to the second aspect of SAND, e.g., the sending of lower resolution versions when the DASH client requests a higher resolution version, SAND provides the AcceptedAlternatives message and the DeliveredAlternative, as indicated in FIG. 12. Using the former, the DASH client 100 may indicate acceptable alternatives during a segment request to the DANE 110. These alternatives are other representations described in the MPD, and may be indicated using the URL. An example of how this may be indicated in the HTTP header is the following:

SAND-AcceptedAlternatives: [sourceURL http://my.cdn.com/video tile1_video_
video_small.mp4″,range=837-988]

When the DANE 110 delivers an alternative segment, it may indicate this using the DeliveredAlternative message. In this message, the original URL requested may be indicated together with the URL of the actually delivered content.

Multi-User Streaming

Although the concept of caching guard bands at a network cache has been previously described with reference to a single client, there may be multiple clients streaming the same VR video at a same time. In such a situation, content parts (e.g. tiles) requested for one viewer may be viewport tiles or guard band tiles for another, and vice versa. This fact may be exploited to improve the efficiency of the caching mechanism.

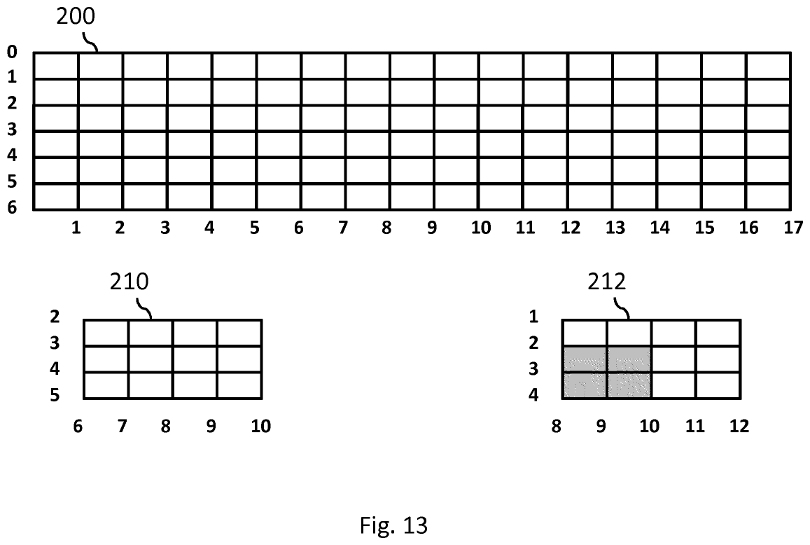

An example is shown in FIG. 13, in which clients A and B are simultaneously viewing a VR video represented by tiles 200. Client A has a current viewport 210 which may be delivered via the cache. Client B has a current viewport 212 which is displaced yet partially overlapping with the viewport 210 of client A, e.g., by being positioned to the right and up. Here, the shaded tiles in the viewport 212 indicate the tiles that overlap, and thus only have to be delivered to the cache once for both clients in the case that the respective viewports are delivered by the cache to the clients.

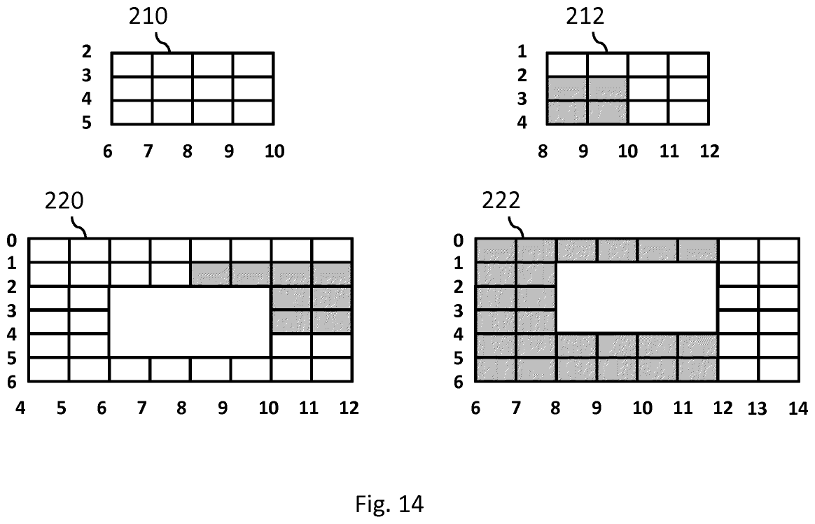

FIG. 14 shows the guard band of tiles 220 which are to be cached for client A. As a number of these tiles are already part of the current viewport 212 of client B (see shaded overlap), these only need to be delivered to the cache once. Moreover, the guard band of tiles 222 for client B overlaps mostly with tiles already requested for client A (see shaded overlap). For client B, only the non-overlapping tiles (rightmost 2 columns of the guard band 222) need to be delivered specifically for client B.

When more clients are viewing the content at the same time, the caching efficiency may be even higher. Moreover, when clients view the content not at exactly the same time, but at approximately the same time, efficiency can still be obtained. Namely, a cache normally retains content for some time, to be able to serve requests for the same content later in time from the cache. This principle may apply here: clients requesting content later in time may benefit from earlier requests by other clients.

Accordingly, when a cache or DANE requests segments from the media server, e.g., as shown in FIGS. 9 and 10, it may first check if certain segments are already available, e.g., have already been cached, or have already being requested from the server. For new requests, the cache only needs to request those segments that are unavailable and have not already been requested, e.g., for another client.

It will be appreciated that yet another way in which multiple successive viewers can lead to more efficiency is to determine the most popular parts of the content. If this can be determined from the viewing behavior of a first number of viewers, this information may be used to determine the most likely parts to be requested and help to determine efficient guard bands. Either all likely parts together may form the guard band, or the guard band may be determined based on the combination of current viewport and most viewed parts by earlier viewers. This may be time dependent: during the play-out, the most viewed areas will likely differ over time.

Timing Aspects

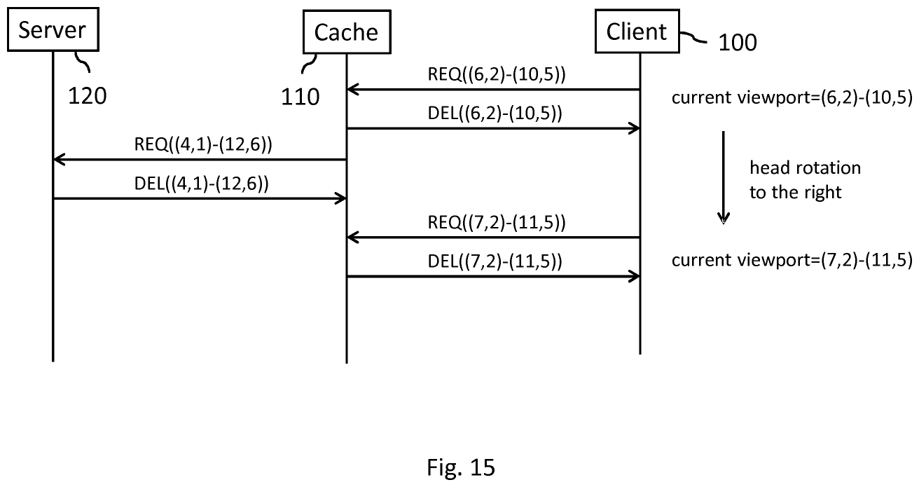

There may be time aspects to the caching of guard bands, which may be explained with reference to FIG. 15 which shows an example of the selective caching of parts of a content timeline of streams within the context of tiled streaming.

In this example, the client 100 may seek to render a certain viewport, in this case (6,2)-(10,5) referring to all tiles between these coordinates. Using tiled streaming, the client 100 may request these tiles from the cache 110, and the cache 110 may quickly deliver these tiles. The cache 110 may then request both the current viewport and an additional guard band from the server 120. The cache 110 may thus request (4,1)-(12,6). The user may then rotate his/her head to the right, and in response, the client 100 may request the viewport (7,2)-(11,5). This is within range of the guard bands, so the cache 110 has the tiles and can deliver them to the client 100.

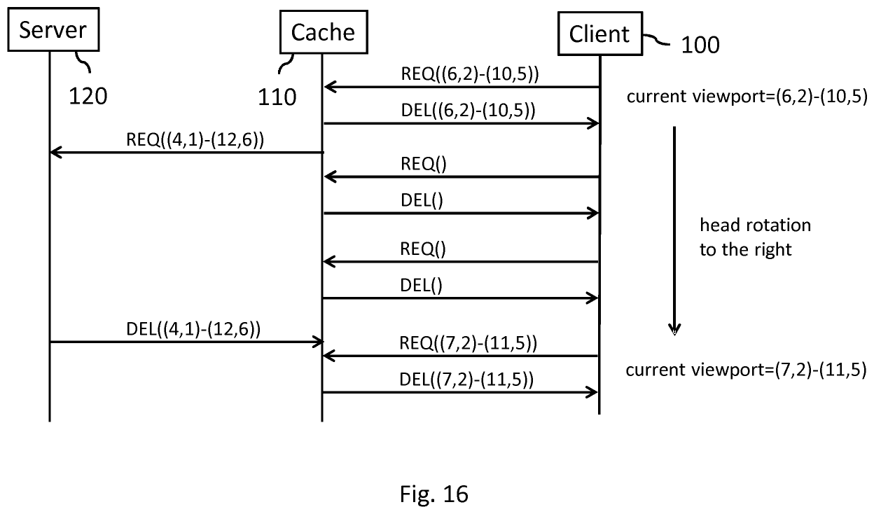

FIG. 16 shows a variant of the example of FIG. 15 in which the client 100 requests new tiles before the tiles of a previous guard band are delivered. In this example, after the first request from the client 100, the cache 110 may deliver the requested tiles and again request new tiles including guard band tiles. However, before said tiles are delivered by the server 120 to the cache 110, two additional requests arrive from the client 100. This may be a typical situation, as the cache 110 may be closer to the client 100 than to the server 120 in terms of network distance, e.g., as measured by number of hops, ping time, number of nodes along the network path, etc. Accordingly, the selection of the guard band may need to take the delivery time into account: how far may the user rotate his/her head in the time that is needed to get new segments from the media server to the cache? Preferably, the guard band is sufficiently large to cope with the typical head rotation, e.g., for 50%, 75%, 80%, 90% or 95% of the time. It will be appreciated that the determination of the size of the guard bands is also further onwards discussed with reference to ‘Guard band size’.

Moreover, in DASH, the requests for tiles are made for tiles for a specific point in time. The cache 110 may thus need to determine the point in time for which to request the tiles. In particular, the tiles should represent content at a point in time which matches future requests as well as possible. This relationship may be a fixed, preconfigured relationship, but may also depend on (real-time) measurements. Moreover, also the quality level may be varied. For example, if the retrieval of tiles from the server 120 takes a prolonged time or if the available bandwidth on the network is limited, the cache 110 may, e.g., request guard band tiles in lower quality (as they may not be used) or in decreasing quality, e.g., having a higher quality close to the current viewport and lower quality further away.

FIG. 17 shows a variant of the example of FIG. 15 in which the request of the client is a first request, e.g., before caching of tiles has commenced. As such, FIG. 17 addresses the question of: what happens with the first request of a client? The cache 110 then has no tiles cached yet, and multiple requests may be received from the client 100 before any tiles can be retrieved from the server 120. In general, delivering tiles for previous requests may not be desirable, as the previous requests are based on an previous head position, and thus would lead to large delays between head rotation and video rotation. Accordingly, as shown in FIG. 17, it may be better to not fulfill the first or first few requests. At the client side, non-fulfilled requests may be handled as follows:
With certain streaming mechanisms, the client may be unaware of the media timing, e.g., as in the case of RTP streaming. Here, the client may request content and receives content it can start playing. If the client does not receive anything, play-out will simply go blank. In such a situation, no special measures may be needed.
With DASH, specific tiles may be requested, both spatially and in time (which content time for which tiles). This may be handled in various ways:
Modify the client to start with an AnticipatedRequests message, and temporarily hold off from requests to give the cache time to retrieve segments.
Modify the client so that it does not expect replies on the first and possible following requests, or expect them late. If content is delivered, the client may discard those tiles it receives late, and start playing with the tiles that are delivered immediately after a request, which is in FIG. 17 the delivery following the last request.
The cache itself may send a reply in response to requests which cannot be fulfilled, e.g., by sending a 404 Not Found message. This may indicate to the client that these particular tiles are not available. This may further involve modification of the client so as to be able to interpret and correctly act upon such a message.
The cache may send a dummy response, e.g., by sending tiles which are properly formatted given the request but which contain blank video, e.g., black pixels. Such dummy video packets may be available at the cache in various resolutions or may be created on the fly. This does not involve any client modification.

Guard Band Size

In general, the size of the guard band which is to be cached by the cache may be determined to reflect aspects such as the expected head movement and delays between the cache and the server. For example, the size of the guard band may be dependent on a measurement or statistics of head movement of a user, a measurement or statistics of head rotation of the user, a type of content represented by the VR video, a transmission delay in the network between the server and the network cache, a transmission delay in the network between the network cache and the client, and/or a processing delay of a processing of the first subset of streams by the client. These statistics may be measured, e.g., in real-time, by network entities such as the cache and the client, and may be used as input to a function determining the size of the guard band. The function may be heuristically designed, e.g., as a set of rules.

Moreover, if the content is available at different quality levels, e.g., different resolutions and/or bitrates, parts may be requested at different quality levels depending on any number of the above measurements or statistics. For example, with fast head rotation, larger guard bands in lower quality may be requested, while with slow head rotation, smaller guard bands in higher quality may be requested. This decision may also be taken by the cache itself, e.g., as described with reference to FIG. 12 in the context of SAND. The above change in size and/or quality level may further be combined with adaptive streaming, in which the bandwidth is measured and a ‘right’ bitrate for future segments is determined. As the client may switch to a lower or higher bitrate, segments with the corresponding bitrate may be cached by the cache.

Content Filtering

The selective caching of guard bands may comprise selective transmission or forwarding of substreams. This may be explained as follows. A VR video may be carried in an MPEG-TS (Transport Stream), where the various parts (tiles, segments) are each carried as an elementary stream in the MPEG-TS. Each such elementary stream may be transported as a PES (Packetised Elementary Stream) and have its own unique PID (Packet Identification). Since this PID is part of the header information of the MPEG-TS, it is possible to filter out certain elementary streams from the complete transport stream. This filtering may be performed by a network node to selectively forward only particular elementary streams to the cache, e.g., when the entire MPEG-TS is streamed by the server. Alternatively, the server may selectively transmit only particular elementary streams. Alternatively, the cache may use the PID to selectively store only particular elementary streams of a received MPEG-TS. Such content filtering may also be performed for HEVC encoded streams. An HEVC bitstream consists of various elements each contained in a NAL (Network Abstraction Layer) unit. Various parts (tiles, segments) of a video may be carried by separate NAL units, which each have their own identifier and thus enable content filtering.

Cache Vs Network Delivery Node

It will be appreciated that the described caching may not primarily be intended for buffering. Such buffering is typically needed to align requests and delivery of media, and/or to reduce jitter at the client. The requests from cache to the media server, with the former being preferably located at the edge of the core network near access network to the client, may take more time then the requests from client to the cache. Adding the extra guard bands may allow the cache to deliver segments requested by a client in the future, without knowing the request in advance.

Moreover, throughout this specification, where the term ‘cache’ is used, also ‘content delivery node’ or ‘media aware network element’ or the like may be used. Namely, the cache may not need to be a traditional (HTTP) cache, particularly in view that, depending on the content delivery method, only short caching may be in order.

In general, the entity referred to as cache may be a node in the network, e.g., a network element which is preferably located near the edge of the core network and thereby close towards the access network to the client, and which is able to deliver requested viewports and (temporarily) buffer guard bands. This node may be a regular HTTP cache in the case of DASH, but may also be an advanced Media Aware Network Element (MANE) or another type of delivery node in the Content Delivery Network. It will be appreciated that delivery nodes, such as DANE's in SAND, may perform more functions, e.g., transcoding, mixing, repurposing. In this case, a delivery node may be seen as a type of cache with added functionality to support the streaming.

General Aspects

The caching mechanism may be used in conjunction with various streaming protocols, including but not limited to, e.g. RTSP, RTMP, HLS, etc.

In the examples, the cache generally decides upon the guard bands. The client may also decide upon the guard bands, and indicate this to the cache.

There may be multiple caches provided in series, with caches which are located further up in the hierarchy, e.g., closer to the server, caching a larger size guard band than caches further down in the hierarchy, e.g., closer to the client.

It will be appreciated that the stream sources may be cloud-based, in that the plurality of streams may be streamed from a distributed system of media servers, or in general, may be streamed from a plurality of shared computing resources.

It will be appreciated that, when switching streams, it may be advantageous to ensure than an I-Frame of the new stream(s) is provided to the client as fast as possible. There are several known techniques for this, e.g., from the field of IPTV where they are known as ‘Fast Channel Change’ or ‘Rapid Channel Change’, which may be used in conjunction with the techniques described in this disclosure.

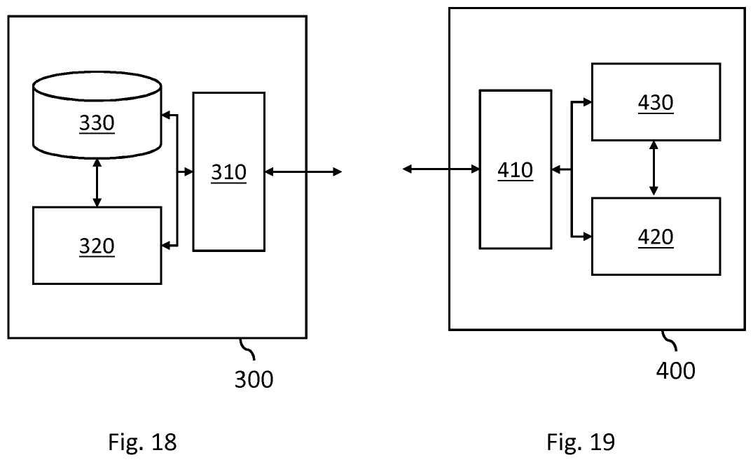

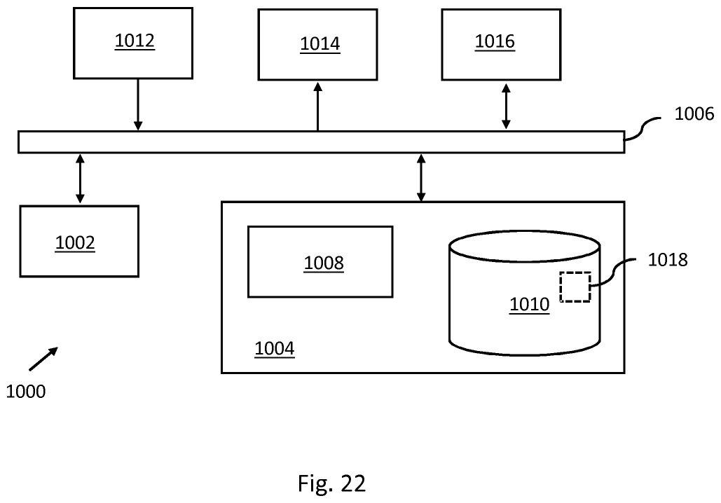

FIG. 18 shows an exemplary network cache 300. The network cache 300 may comprise a network interface 310 for communicating with a network. The network interface 310 may be, but is not limited to, an Ethernet or fiber optic-based local or wide area network (LAN, WAN) interface, or a wireless interface, e.g., according to Wi-Fi, 4G or 5G telecommunication standards. The network cache 300 may further comprise a data storage 330 for caching data, which may be any suitable type of data storage, e.g., one or more hard disks, solid state disks, or other types of data storage. The network cache 300 may further comprise a cache controller 320 configured to obtain spatial relation data which is indicative of a spatial relation between the different image data of the scene as provided by the plurality of streams, identify the one or more streams which are needed to render the selected view, thereby identifying a first subset of streams, using the spatial relation data, identify a second subset of streams which provides image data of the scene which is spatially adjacent to the image data of the first subset of streams, obtain stream metadata which identifies one or more stream sources providing access to the second subset of streams in the network, request, using the network interface, a streaming of the second subset of streams from the one or more stream sources, and cache the second subset of streams in the data storage. The cache controller 320 may be configured to perform any of the caching functions of the caches as described in this specification. Another exemplary embodiment of the cache and its cache controller will be described with reference to FIG. 22.

FIG. 19 shows an exemplary VR rendering device 400, which may comprise a network interface 410 for communicating with a network. The network interface 410 may be, but is not limited to, an Ethernet or fiber optic-based local or wide area network (LAN, WAN) interface or a wireless interface, e.g., according to Wi-Fi, 4G or 5G telecommunication standards. The VR rendering device 400 may further comprise a display processor 420 configured to render a selected view of the scene on the basis of one or more of the plurality of streams. Such display processors 420 are known per se in the art, and may but do not need to include one or more Graphics Processing Units (GPUs). The VR rendering device 400 may further comprise a controller 430 configured to obtain spatial relation data which is indicative of a spatial relation between the different image data of the scene as provided by the plurality of streams, identify the one or more streams which are needed to render the selected view, thereby identifying a first subset of streams, using the spatial relation data, identify a second subset of streams which provides image data of the scene which is spatially adjacent to the image data of the first subset of streams, and effect a caching of the second subset of streams in a network cache which is comprised downstream of the one or more stream sources in the network and upstream of the VR rendering device by sending, using the network interface, a message to the network cache or to one or more stream sources which provide access to the second subset of streams in the network, wherein the message comprises instructions to cache the second subset of streams in the network cache. In case the message is to be sent to the one or more stream sources, the controller may be configured to obtain stream metadata which identifies the one or more stream sources which provide access to the second subset of streams in the network. Another exemplary embodiment will be described with reference to FIG. 22.

It will be appreciated that the VR rendering device 400 may comprise one or more displays for displaying the rendered VR environment. For example, the VR rendering device 400 may be a VR headset, e.g., referring to a head-mountable display device, or a smartphone or tablet device which is to be used in a VR enclosure, e.g., of a same or similar type as the ‘Gear VR’ or ‘Google Cardboard’. Alternatively, the VR rendering device 400 may be device which is connected to a display or VR headset and which provides rendered images to the display or VR headset for display thereon. A specific example is that the VR rendering device 400 may be represented by a personal computer or game console which is connected to a separate display or VR headset, e.g., of a same or similar type as the ‘Oculus Rift’, Vive′ or ‘PlayStation VR’. Other examples of VR rendering devices are so-termed Augmented Reality (AR) devices that are able to play-out VR video, such as the Microsoft HoloLens.

Moreover, although not shown in FIG. 19, the VR rendering device 400 may comprise one or more memories, which may be used for various purposes, including but not limited to storing data which may be received from the cache or the server.

It is noted that the VR rendering device may be aware of when to switch streams on the basis of a measured head rotation or head movement of a user. Here, ‘switching streams’ refers to at least a new stream being requested, and the streaming of a previous stream being ceased. It is noted that measuring the head rotation or head movement of a user is known per se in the art, e.g., using gyroscopes, cameras, etc. The head rotation or head movement may be measured by the VR rendering device itself, e.g., by comprising a gyroscope, camera, or camera input connected to an external camera recording the user, or by an external device, e.g., an external VR headset connected to the VR rendering device or an external camera recording the VR headset from the outside, e.g., using so-termed ‘outside-in’ tracking, or a combination thereof. Moreover, although the switching of streams may be in response to a head rotation or head movement, the invention as claimed is not limited thereto, as there may also be other reasons to render a different view of the panoramic scene and thereby to switch streams. For example, the switching of streams may be in anticipation of a head movement, e.g., because a sound associated with the VR video from a certain direction may trigger the user to rotate his head into that certain direction, with an oncoming occurrence of the sound triggering the switching.

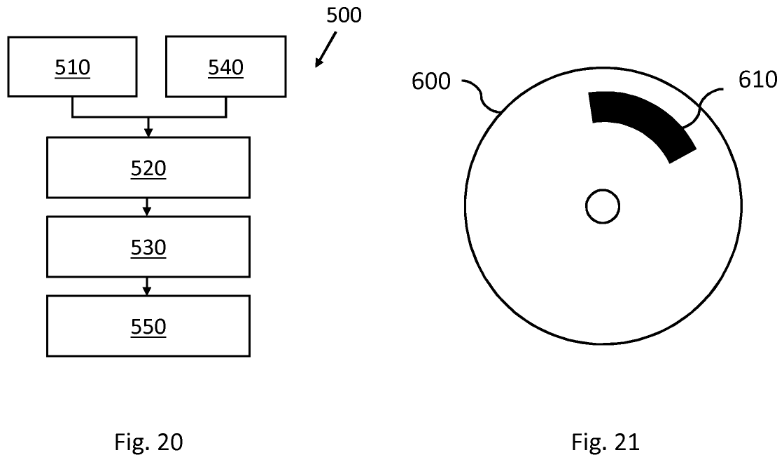

FIG. 20 shows a method 500 for streaming a VR video to a VR rendering device. The method 500 may comprise, in an operation titled “OBTAINING SPATIAL RELATION DATA”, obtaining 510 spatial relation data which is indicative of a spatial relation between the different image data of the scene as provided by the plurality of streams. The method 500 may further comprise, in an operation titled “IDENTIFYING NEEDED STREAM(S)”, identifying 520 the one or more streams which are needed to render the selected view, thereby identifying a first subset of streams. The method 500 may further comprise, in an operation titled “IDENTIFYING GUARD BAND STREAM(S)”, using the spatial relation data, identifying 530 a second subset of streams which provides image data of the scene which is spatially adjacent to the image data of the first subset of streams. The method 500 may further comprise, in an operation titled “OBTAINING STREAM METADATA”, obtaining stream metadata 540 which identifies one or more stream sources providing access to the second subset of streams in a network. The method 500 may further comprise, in an operation titled “EFFECTING CACHING OF GUARD BAND STREAM(S)”, effecting 550 a caching of the second subset of streams in a network cache which is comprised downstream of the one or more stream sources in the network and upstream of the VR rendering device. It will be appreciated that the above operation may be performed in any suitable order, e.g., consecutively, simultaneously, or a combination thereof, subject to, where applicable, a particular order being necessitated, e.g., by input/output relations. For example, operations 510 and 540 may be performed simultaneously.

The method 500 may be implemented on a processor system, e.g., on a computer as a computer implemented method, as dedicated hardware, or as a combination of both. As also illustrated in FIG. 21, instructions for the computer, e.g., executable code, may be stored on a computer readable medium 600, e.g., in the form of a series 610 of machine readable physical marks and/or as a series of elements having different electrical, e.g., magnetic, or optical properties or values. The executable code may be stored in a transitory or non-transitory manner. Examples of computer readable mediums include memory devices, optical storage devices, integrated circuits, servers, online software, etc. FIG. 21 shows an optical disc 600.

Alternatively, the computer-readable medium 600 may comprise stream metadata or spatial relation data as described elsewhere in this specification.

FIG. 22 is a block diagram illustrating an exemplary data processing system that may be used in the embodiments of this disclosure. Such data processing systems include data processing entities described in this disclosure, including but not limited to the VR rendering device and the forwarding node. Data processing system 1000 may include at least one processor 1002 coupled to memory elements 1004 through a system bus 1006. As such, the data processing system may store program code within memory elements 1004. Further, processor 1002 may execute the program code accessed from memory elements 1004 via system bus 1006. In one aspect, data processing system may be implemented as a computer that is suitable for storing and/or executing program code. It will be appreciated, however, that data processing system 1000 may be implemented in the form of any system including a processor and memory that is capable of performing the functions described within this specification.

Memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The processing system 1000 may also include one or more cache memories (not shown) that provide temporary storage of at least some program code in order to reduce the number of times program code must be retrieved from bulk storage device 1010 during execution.

Input/output (I/O) devices depicted as input device 1012 and output device 1014 may optionally be coupled to the data processing system. Examples of input devices may include, but are not limited to, for example, a microphone, a keyboard, a pointing device such as a mouse, or the like. Examples of output devices may include, but are not limited to, for example, a monitor or display, speakers, or the like. Input device and/or output device may be coupled to data processing system either directly or through intervening I/O controllers. A network adapter 1016 may also be coupled to, or be part of, the data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1000.

As shown in FIG. 22, memory elements 1004 may store an application 1018. It should be appreciated that the data processing system 1000 may further execute an operating system (not shown) that may facilitate execution of the application. The application, being implemented in the form of executable program code, may be executed by data processing system 1000, e.g., by the processor 1002. Responsive to executing the application, the data processing system may be configured to perform one or more operations to be described herein in further detail.

In one aspect, for example, the data processing system 1000 may represent a VR rendering device. In that case, the application 1018 may represent an application that, when executed, configures the data processing system 1000 to perform the various functions described herein with reference to the VR rendering device, or in general ‘client’, and its processor and controller. Here, the network adapter 1016 may represent an embodiment of the input/output interface of the VR rendering device. In another aspect, the data processing system 1000 may represent a network cache. In that case, the application 1018 may represent an application that, when executed, configures the data processing system 1000 to perform the various functions described herein with reference to the network cache and its cache controller.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for use in streaming a Virtual Reality [VR] video to a VR rendering device, wherein the VR video is represented by a plurality of streams each providing different image data of a scene, wherein the VR rendering device is configured to render a selected view of the scene on the basis of one or more of the plurality of streams, the method comprising:
obtaining spatial relation data which is indicative of a spatial relation between the different image data of the scene as provided by the plurality of streams;
identifying the one or more streams which are needed to render the selected view, thereby identifying a first subset of streams;
identifying, by using the spatial relation data, a second subset of streams which provides image data of the scene which is spatially adjacent to the image data of the first subset of streams;
obtaining stream metadata which identifies one or more stream sources providing access to the second subset of streams in a network; and
effecting a caching of the second subset of streams in a network cache which is comprised downstream of the one or more stream sources in the network and upstream of the VR rendering device.

2. The method according to claim 1, further comprising:
obtaining a prediction of which adjacent image data of the scene may be rendered by the VR rendering device; and
identifying the second subset of streams based on the prediction.

3. The method according to claim 2, wherein the VR rendering device is configured to determine the selected view of the scene in accordance with a head movement and/or head rotation of a user, and wherein the obtaining the prediction comprises obtaining tracking data indicative of the head movement and/or the head rotation of the user.

4. The method according to claim 1, further comprising selecting a spatial size of the image data of the scene which is to be provided by the second subset of streams based on at least one of:
a measurement or statistics of head movement of a user;
a measurement or statistics of head rotation of a user;
a type of content represented by the VR video;
a transmission delay in the network between the one or more stream sources and the network cache;
a transmission delay in the network between the network cache and the VR rendering device; and
a processing delay of a processing of the first subset of streams by the VR rendering device.

5. The method according to claim 1, wherein the second subset of streams is accessible at the one or more stream sources at different quality levels, and wherein the method further comprises selecting a quality level at which the second subset of streams is to be cached based on at least one of:
an available bandwidth in the network between the one or more stream sources and the network cache;
an available bandwidth in the network between the network cache and the VR rendering device; and
a spatial size of the image data of the scene which is to be provided by the second subset of streams.

6. The method according to claim 1, further comprising:
receiving a request from the VR rendering device for streaming of the first subset of streams;
identifying the first subset of streams on the basis of the request.

7. The method according to claim 6, further comprising, in response to the receiving of the request:
if available, effecting a delivery of one or more streams of the first subset of streams from the network cache; and
for one or more other streams of the first subset of streams which are not available from the network cache,
jointly requesting the one or more other streams with the second subset of streams from the one or more stream sources,
effecting a delivery of the one or more other streams to the VR rendering device, while effecting the caching of the second subset of streams in the network cache.

8. The method according to claim 1, wherein the stream metadata is a manifest such as a media presentation description.

9. The method according to claim 1, wherein the method is performed by the network cache or the one or more stream sources.

10. The method according to claim 1, wherein the effecting the caching of the second subset of streams comprises sending a message to the network cache or the one or more stream sources comprising instructions to cache the second subset of streams in the network cache.

11. The method according to claim 1, wherein the method is performed by the VR rendering device.

12. The method according to claim 10, wherein the method is performed by the VR rendering device, wherein the VR rendering device is a MPEG Dynamic Adaptive Streaming over HTTP [DASH] client, and wherein the message is a Server and Network Assisted DASH [SAND] message to a DASH Aware Network Element [DANE], such as an ‘AnticipatedRequests’ message.

13. A transitory or non-transitory computer-readable medium comprising a computer program, the computer program comprising instructions for causing a processor system to perform the method according to claim 1.

14. A network cache for use in streaming a Virtual Reality [VR] video to a VR rendering device, wherein the VR video is represented by a plurality of streams each providing different image data of a scene, wherein the VR rendering device is configured to render a selected view of the scene on the basis of one or more of the plurality of streams, the network cache comprising:
a network interface for communicating with a network;
a data storage for caching data;
a cache controller configured to:
obtain spatial relation data which is indicative of a spatial relation between the different image data of the scene as provided by the plurality of streams;
identify the one or more streams which are needed to render the selected view, thereby identifying a first subset of streams;
identify, by using the spatial relation data, a second subset of streams which provides image data of the scene which is spatially adjacent to the image data of the first subset of streams;
obtain stream metadata which identifies one or more stream sources providing access to the second subset of streams in the network;
request, using the network interface, a streaming of the second subset of streams from the one or more stream sources; and
cache the second subset of streams in the data storage.

15. A Virtual Reality [VR] rendering device for streaming a VR video, wherein the VR video is represented by a plurality of streams each providing different image data of a scene, the VR rendering device comprising:
a network interface for communicating with a network;
a display processor configured to render a selected view of the scene on the basis of one or more of the plurality of streams; and
a controller configured to:
obtain spatial relation data which is indicative of a spatial relation between the different image data of the scene as provided by the plurality of streams;
identify the one or more streams which are needed to render the selected view, thereby identifying a first subset of streams;
identify, by using the spatial relation data, a second subset of streams which provides image data of the scene which is spatially adjacent to the image data of the first subset of streams; and
effect a caching of the second subset of streams in a network cache which is comprised downstream of the one or more stream sources in the network and upstream of the VR rendering device by sending, using the network interface, a message to the network cache or to one or more stream sources which provide access to the second subset of streams in the network, wherein the message comprises instructions to cache the second subset of streams in the network cache.
